(19) United States
(12) Patent Application Publication
(10) Pub. No.: US 2007/0288467 A1
(43) Pub. Date: Dec. 13, 2007

(54) METHOD AND APPARATUS FOR HARMONIZING THE GATHERING OF DATA AND ISSUING OF COMMANDS IN AN AUTONOMIC COMPUTING SYSTEM USING MODEL-BASED TRANSLATION

(75) Inventors: John C. Strassner, North Barrington, IL (US); Barry J. Menich, South Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/422,642

(22) Filed: Jun. 7, 2006

(51) Int. Cl. G06F 17/30

(52) U.S. Cl. 707/10

(57) ABSTRACT

A system includes vendor specific converters [210, 215, 220, 225] to gather vendor-specific data from sensors [235, 240] and convert to normalized data. The vendor-specific data comprises at least a first input and a second input. The first input corresponds to a first language and the second input corresponds to a second language, where the first language is different from the second language. The vendor specific converters [210, 215, 220, 225] receive normalized commands and issue vendor-specific commands to a managed resource [165]. A converter module [230] receives the normalized data and converts to an output corresponding to a common language. The converter module [230] also receives and outputs normalized commands corresponding to the common language. Semantic processing logic [255] receives the normalized data and matches the normalized data against a predetermined set of knowledge bases and generates a new object to send to an autonomic manager [160].

### RELATED APPLICATIONS

“AUTONOMIC COMPUTING METHOD AND APPARATUS” as is filed concurrently with present application using attorney's docket number CML03322N;

“METHOD AND APPARATUS FOR AUGMENTING DATA AND ACTIONS WITH SEMANTIC INFORMATION TO FACILITATE THE AUTONOMIC OPERATIONS OF COMPONENTS AND SYSTEMS” as is filed concurrently with present application using attorney's docket number CML03000N; and

“PROBLEM SOLVING MECHANISM SELECTION FACILITATION APPARATUS AND METHOD” as is filed concurrently with present application using attorney's docket number CML03124N;

wherein the contents of each of these related applications are incorporated herein by this reference.

### TECHNICAL FIELD

This invention relates generally to the fields of network and element management, including different means to realize such systems (such as Web Services and grid services), and more particularly to the field of self-managing and self-governing (i.e., autonomic) computing systems.

### BACKGROUND

Networks are often comprised of heterogeneous computing elements, each with their own distinct set of functions and approaches to providing commands and data regarding the operation of those functions. Elements may assume different roles and functions over time and in certain contexts, which in turn requires their configuration to vary. The problem is that even the same product from the same vendor can run multiple versions of a device operating system, and be programmed using different languages. As a consequence, these computing elements may (and often do) have different, incompatible formats for providing data and receiving commands.

Currently, management elements are built in a custom/stovepipe fashion precisely because of the above limitations. This leads to solution robustness burdened by scalability problems. More importantly, it prohibits management systems from sharing and communicating decisions on similar data and commands. Hence, additional software must be built for each combination of management systems that need to communicate.

There are many Element Management Systems (“EMSs”) in the marketplace. The overwhelming majority are “hardwired” to accept data and issue commands for a small set of devices. EMSs manufactured by a network device vendor, such as CiscoWorks for Cisco Systems, do not typically manage network devices for other vendors, simply because it is not in the best interest of that vendor to manage devices of other vendors.

A current system uses pre-processing of the command syntax of a vendor to develop an Extensible Markup Language (“XML”)-based representation of that vendor's language. Hence, when this system communicates with a device, that communication is akin to looking up words in a dictionary. For example, if this system has parsed the particular version of software that the device is using, then the data and commands will be in the system's dictionary. If they have not been parsed, they will not. Furthermore, there is no way to extend this system's dictionary dynamically, i.e., adding terms to this system's dictionary is an expensive set of processes that must be run before the system's software communicates with a device. There is also no way for policy to be used to control the gathering of information, issuing of commands, and parsing of received data. Finally, there is no way for this system to learn or reason about data it receives or commands that it sends, as this would require a human operator or a pre-defined script. This current system therefore provides only a pre-defined dictionary-based communication. It also utilizes static definitions of commands and data and relies on pre-processing the common syntax of a vendor.

An exemplary autonomic computing system defines sensors and effectors as part of a closed control loop to gather information from and control a device, respectively. When confronted with heterogeneous devices, however, this system only offers the ability to package these different data into a common event format for further processing. This system does not explain how to facilitate the communication of heterogeneous devices that use different languages. This system has no ability to parse new events and/or data, i.e., all it can do is package that data into a common container for future processing. It also lacks an ability to harmonize different representations of the same events and/or data (e.g., for upgrading commands in a previous operating system release to a new version of the operating system). It does not differentiate between different types of inputs on its sensors and outputs from its effectors. There is no way for policy to be used to control the gathering of information, issuing of commands, and parsing of received events and/or data. Finally, it has only limited ability to learn about received events and/or data, and it cannot reason about received events and/or data.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a conceptual block diagram of an autonomic system based on using a Directory Enabled Network-next generation (“DEN-ng”) model according to at least one illustrative embodiment;

FIG. 2 illustrates a block diagram of harmonization logic according to at least one illustrative embodiment;

FIG. 3 illustrates a simplified flowchart for the model-based processing logic according to at least one illustrative embodiment;

FIG. 4 illustrates a functional block diagram of the semantic processing logic according to at least one illustrative embodiment;

FIG. 5 illustrates the object construction and semantic augmentation processing according to at least one illustrative embodiment;

FIG. 6 illustrates an object represented in UML according to the prior art; and

FIG. 7 illustrates a semantically augmented object that accords with these teachings.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a method, apparatus, and system are provided that describe a set of mechanisms that translate data and commands in multiple distinct formats from multiple different vendors into a single harmonized form using a combination of one or more programming methods in conjunction with object-oriented information modeling and semantic knowledge. It also includes facilities to dynamically adapt to and incorporate new data and information formats. A method, apparatus, and system are also provided that describe a set of mechanisms that translate data in the single harmonized form back into multiple distinct formats from multiple different vendors using a combination of one or more programming methods in conjunction with object-oriented information modeling and semantic knowledge. Thus, according to these teachings, a single computing system can acquire data from and issue commands to different devices, even if those devices cannot communicate directly with each other.

In the context of these teachings, “a single harmonized form” means that data and commands are automatically translated to a common format within the autonomic system, and vice-versa. This provides at least three important benefits for computing systems. First, it allows different devices and computing systems using different languages to communicate with each other (through the autonomic system) by defining a common communication and control mechanism. Second, it facilitates the use of policy governing processing logic that is independent of an underlying implementation. Third, it facilitates the use of machine learning and reasoning techniques to actively observe the common format stream and, based on those observations, adjust other control and management processes of the autonomic system. For example, a policy written to govern a network comprising Cisco routing equipment would immediately apply to equivalent networks implemented using routing equipment of other vendors, even though their configuration systems differ markedly. As another example, knowledge-based reasoning can observe the output of the harmonization process and recommend the collection of different data (as well as changing which aspects of which managed resources are being observed) based on the type and frequency of received data and events from the original managed resource.

Complexity takes two fundamentally different forms—system and business complexity. Complexity arising from system and technology is spurred on in part by the inexorability of Moore's Law. This is one reason why programmers have been able to exploit increases in technology to build more functional software and more powerful systems. Functionality, however, comes at a price, and the price that has been paid is the increased complexity of system installation, maintenance, (re)configuration, and tuning. The trend is for this complexity to increase—not only are systems exceedingly complex now, but the components that build them are themselves complex stovepipes, consisting of different programming models and requiring different skill sets to manage them. Furthermore, systems will always become more complex, because everyone wants more for less.

The complexity of doing business is also increasing because end-users want simplicity. Ubiquitous computing, for example, motivates the move from a keyboard-based to a task-based model, enabling the user to perform a variety of tasks using multiple input devices in an “always connected” presence. This requires an increase in intelligence in the system, which is where autonomics comes in. Autonomics enables governance models to drive business operations and services. Autonomics helps by defining and enforcing a consistent governance model to simplify management.

Currently, too much time is being spent in building infrastructure. This is a direct result of people concentrating on technology problems instead of how business is conducted. There is a good reason for this. Concentrating on just the network, different devices have different programming models, even from the same vendor. For example, there are over 250 variations of Cisco IOS 12.0S. This simply represents the Service Provider feature set of IOS, and there are many other different features sets and releases that can be chosen. Worse, the Cisco 6500 Catalyst switch can be run in Internetwork Operating System (“IOS”), CatOS, or hybrid mode, meaning that both the IOS and the CatOS operating systems can be run at the same time in a single device.

A common Service Provider environment is one in which the Command Line Interface (“CLI”) of a device is used to configure it, and Simple Network Management Protocol (“SNMP”) is used to monitor the performance of the device. But a problem arises when mapping between SNMP commands and CLI commands. There is no standard to do this, which implies that there is no easy way to prove that the configuration changes made in CLI solved the problem. Since networks often consist of specialized equipment, each with their own language and programming models, the demand for these teachings is very strong.

These teachings provide a system in which the infrastructure can be taken care of automatically, enabling more time to be spent defining the business logic necessary to build a solution. Business logic is comprised of both commands and data. Sensors need to understand the data that they are monitoring, so if two devices use two different languages (such as CLI and SNMP), then a common language needs to be used to ensure that each device is being told the same thing. Some approaches strive to provide any data to any user over any media to any device. These approaches demand knowledge engineering to be used in conjunction with networking in order to achieve its primary goal of letting the business drive the services and resources that are provided.

A primary business imperative is to be able to adjust the services and resources provided by the network in accordance with changing business policies and objectives, user needs, and environmental conditions. In order to do this, the system needs a robust and extensible representation of the current state of the system, and how these three changes affect the state of the system.

The system also needs the ability to abstract the functionality of components in the system into a common form, so that the capabilities of a given component are known, and any constraints (business, technical and other) that are applied to that component are known. This enables the system to be, in effect, “reprogrammed” so that it can adjust to faults, degraded operations, and/or impaired operations. In order to relate business goals and objectives to network services and resources, a common representation and language are needed. A common representation enables the different information and their semantics to be understood, and a common language ensures that the result can be machine-programmable.

The term “autonomic computing” invites parallels to the biological connotation of the autonomic nervous system. Specifically, people do not typically think about pumping blood or regulating their sugar levels at every waking moment of their lives. This frees their brains to concentrate on other tasks. Similarly, autonomic computing frees managers and administrators from governing low-level, yet critical, tasks of a system so that business may proceed as planned without requiring highly trained specialists to watch the system and continually attempt to manually adjust its every operation. This does not imply that an autonomic system does not need humans to operate it. Instead, the purpose of an autonomic system is to simplify and manage the complexity of the environment so that skilled resources can be better leveraged.

One important point about autonomic computing, as described below, is that it typically refers to a “self-governing” system. This is in direct contrast to common definitions of autonomic computing in the art, which emphasize a “self-managing” system. These teachings are directed toward use a “self-governing” system because most examples today of self-managing systems use a statically defined set of rules to govern their operation. The self-managing systems of today, however, encounter problems when the business changes its priorities, the needs of the user change, and/or environmental conditions change. A statically defined rule set cannot adapt to these and other changes if they are not anticipated and pre-defined in the set of static policy rules. These and other changes in and to the managed environment necessitate a governance model, i.e., one in which changes are made in order to optimize the underlying business rules that control the services and resources being offered at any one time.

These teachings generally enable such underlying business rules to reflect changes in the needs of the organization, the needs of users that are using network services and resources, and the ability to respond appropriately to environmental conditions. This requires a common definition of data gathered from the system and environment as well as commands issued to the system. It also requires policies and processes to change in accordance with these three types of changes.

It is the holistic combination of policy and process, under a governance model, that enables autonomic elements to reflect those changes in a structured manner. Hence, the autonomic system described herein is one in which each autonomic element has knowledge of itself and of its environment. For the purposes of the examples described below, “knowledge” comes in two distinct forms. Static knowledge refers to facts that the system has pre-loaded. Dynamic knowledge refers to the ability to reason about its stored facts, stored processes, and sensor inputs, and infer new facts.

There are several forms of knowledge that the system has. The most basic consists of facts that can be accessed as part of a rule-based or case-based reasoning process. An example of this is the reception of sensor data, i.e., received data and/or events are matched to predefined facts so that the received data and/or events can be identified. The next basic type of knowledge consists of the ability to learn about data. An example of the ability to learn about data is that the reception of sensor data and/or events can be compared to a history of prior occurrences of data and/or events, and the system can determine the significance of the data and/or events.

As discussed herein, the autonomic system may include sensors and effectors. A sensor is an entity, e.g. a software program that detects and/or receives data and/or events from other system entities. An effector is an entity, e.g. another software program that performs some action based on the received data and/or events. For example, in the case of a router malfunction, the sensors may receive data corresponding to the malfunction, and the effectors may implement corrective action to fix the malfunction.

A third form of knowledge is the ability of the autonomic system to use knowledge to reason about received data and/or events and draw its own conclusions as to the meaning and/or significance of the data and/or events received. For example, received data and/or events can be correlated with other facts and information already processed by the system to define a first approximation as to the significance of the received events and/or data and possibly derive a “root cause”. Another example is that the reception of data and/or events can itself be used by the system to direct the gathering of additional data and/or events in order to determine the significance of the data and/or events originally received.

The final form of knowledge is state. In other words, the system is aware of the set of states that an element (or aggregate of elements) may occupy and the internal and external forcing functions causing state transitions. This is a crucial capability of an autonomic system, i.e., if the system is to orchestrate the behavior of its constituent elements, then the system must have some representation of the different states that each of its constituent elements will pass through. The teachings presented below use the concept of finite state machines for this representation. This enables the system to define state transition frequencies and/or probabilities, additional pieces of knowledge that the system may draw upon in analysis activities. Drawing from the Directory Enabled Network-next generation (“DEN-ng”) paradigm (which itself is unique in the industry), it uses policy to control the occurrence of state transitions.

Self-knowledge enables self-governance because knowledge of the element, system, and its environment is required in order for governance to exist. Once that is accomplished, one can then look for inspiration from biological, economic, social, and other types of behavior that the autonomic literature describes. However, it is arguable that the full capabilities of autonomic computing will never be realized unless self-governance is realized first. Therefore, these teachings are crucial because they provide the foundation processes for managing heterogeneous devices (which may use different languages and different forms for representing commands and data) in a common way.

The teachings discussed below connect, in a scalable fashion, a multiplicity of devices having vendor-specific languages to an autonomic computing system. In particular, different inputs are accepted from a multiplicity of sensors (each one of which can be in a different language), one or more computational functions are performed on them (e.g., correlation and filtering) as directed by an autonomic manager, and their inputs are harmonized into a single common form for use by the autonomic system. Similar functions are performed in the reverse way for effectors, i.e., commands are translated from a common form used by the autonomic system into vendor-specific commands, and then those commands are issued to a multiplicity of devices that are controlled.

These teachings provide a compression function uplink and a decompression function downlink to the autonomic manager. For example, removal of duplicate events and/or data is a form of compression uplink to the control loop. A complicated plan (series of steps) is a decompression of a command downlink. Another example is sensor data compression of received events and/or data, and effector data decompression from work plans and state changes.

There are a number of advantages of these teachings. It scales through modularity, e.g. new devices can be controlled by adding a new module built to do device-specific translation. This is superior to placing this functionality directly in the autonomic management portion of the system, since by using this placement, the autonomic manager must then have device-specific knowledge about each and every device that it needs to manage. In contrast, these teachings place this translation function into a pre-processor that then provides information to the autonomic manager. It scales through software reuse—the building of a new device translator can reuse software from existing device translators. More importantly, it does not adversely affect other parts of the autonomic system.

It pre-processes information for the autonomic system, thereby decreasing the complexity of the autonomic manager (the principle of autonomics defines many simple functions to do a complex task instead of a single complex function to do a complex task). It also abstracts the specification of this function from any specific implementation. Hence, it can be used with new and/or legacy devices. It uses a plurality of approaches to translate and, more importantly, attach semantic meaning, to the received events and/or data. It uses case-based reasoning using facts defined in an information model to achieve an inherently modular and efficient structure to the translation process, which is lacking in prior systems. It also uses machine learning to avoid costly computational effort by quickly recognizing previous occurrences of received events and/or data and efficiently defining their meaning.

It uses knowledge-based reasoning and state awareness to attach semantics to received data and events, thereby reducing the processing required in the autonomic computing management system. It also enables new data to be dynamically recognized and categorized by using a plurality of information modeling, ontology engineering, machine learning, and knowledge-based reasoning processes. It further provides an extensible framework which can accommodate different sets of knowledge on an application-specific basis.

Additional advantages of this architecture include the following. It uses policy-based management techniques to govern which types of data it is looking for, and which set of commands it will issue. Policy-based management techniques can also be used for governing how to represent data—this is an important and often overlooked point, as it enables the translation and harmonization of the data to match the needs of the program and/or application that is requesting it. It uses machine learning techniques to learn behavior for elements and aggregates of elements to adjust internal representations to state and events allowable under various states. It also uses machine learning techniques to learn behavior sufficient to assist in predictive or inductive inferencing operations (i.e., inductive hypothesis generation). It further uses knowledge-based reasoning techniques to alter the gathering of data according to previous data and current hypotheses that are generated (e.g., through abductive and inductive hypothesis generation).

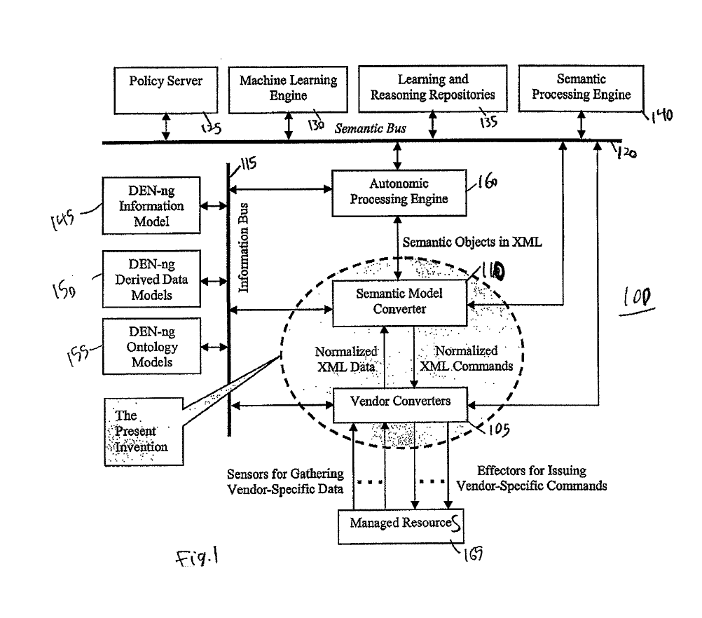

FIG. 1 illustrates a conceptual block diagram of an autonomic system 100 based on using the DEN-ng model according to at least one illustrative embodiment. These teachings fit into this overall framework in two ways. First, it includes the combination of the vendor converters 105 and a semantic model converter 110, which perform the set of functions previously described. Second, it includes a set of interfaces to an information bus 115 and a semantic bus 120, so that it can receive direction and obtain additional knowledge to perform its tasks.

As shown in FIG. 1, the autonomic system 100 includes a policy server 125, a machine learning engine 130, learning and reasoning repositories 135, and a semantic processing engine 140, all of which are in communication with a semantic bus 120. The autonomic system 100 also includes several DEN-ng entities, i.e., a DEN-ng information model 145, DEN-ng derived data models 150, and DEN-ng ontology models 155, all of which are in communication with the information bus 115. An autonomic processing engine 160 is in communication with the semantic bus 120, the information bus 115, and the semantic model converter 110. The vendor converters 105 receive vendor-specific data from managed resources 165. Sensors (not illustrated) may be utilized, e.g. to gather the vendor-specific data. The vendor converters 105 also transmit vendor-specific commands to the managed resources 165. Effectors (not illustrated) may be utilized to transmit the commands. The vendor converters 105 may transmit normalized Extensible Markup Language (“XML”) data to the semantic model converter 110, and may receive normalized XML commands from the semantic model converter 110.

These teachings utilize the information model to establish facts to compare received sensor data and events against. These facts include characteristics and behavior of entities, along with relationships between different entities and to the environment and users of the system. As discussed above, these teachings are based on using the DEN-ng model, which does this as a function of the state of the system and managed resources contained in the system. Other information and data models may also be used, as long as they have the equivalent functionality of DEN-ng. Otherwise, missing functionality must be made up with custom software.

Unfortunately, facts in and of themselves are typically not sufficient for establishing the meaning of why data was received, or what other relationships that are not already defined in the model could exist. Models are also not suitable for identifying contextual changes that occur over time, as well as advanced types of relationships (e.g., “similar to”). Hence, these teachings augment the data present in the information model with additional data from a semantic framework, consisting of a set of ontologies and knowledge-based reasoning, as discussed in related U.S. patent application Ser. No. ______, entitled “METHOD AND APPARATUS FOR AUGMENTING DATA AND ACTIONS WITH SEMANTIC INFORMATION TO FACILITATE THE AUTONOMIC OPERATIONS OF COMPONENTS AND SYSTEMS,” as was filed on ______ using attorney's docket number CML03000N, the disclosure of which is incorporated by reference herein.

These teachings connect, in a scalable fashion, a multiplicity of devices having vendor-specific languages to a computing system. However, these teachings are optimized to serve the needs of an autonomic computing system. In particular, different inputs may be accepted from a multiplicity of sensors (each one of which can supply data from a different language), perform one or more computational functions on them (e.g., correlation and filtering) as directed by installed policies and/or from an autonomic manager, and harmonize their inputs into a single common language, such as XML, for use by the autonomic system. This is different from a prior system, which packages separate data and events into a common event structure. The teachings described herein allow for similar functions to be performed in reverse for effectors, ie., it translates from a common language used by the autonomic system into vendor-specific commands, and then issues those commands to the set of devices that it controls.

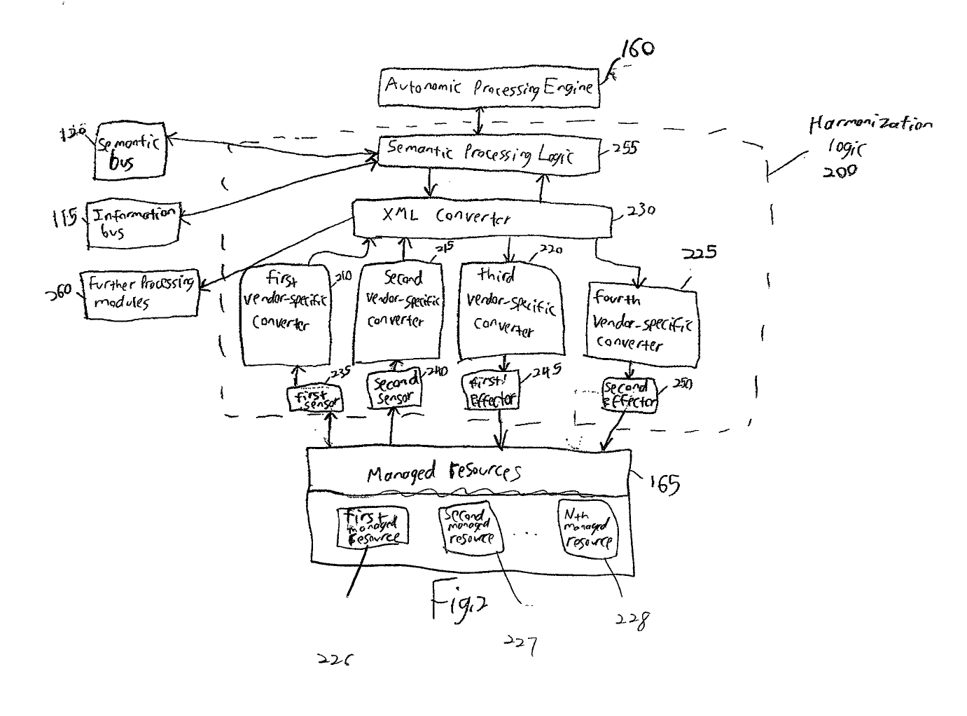

These teachings recognize that managed resources 165 may often provide different data in different granularities using different protocols in different data formats. This is accommodated by enabling one or more sensors to be connected to the managed resources 165 to gather these different data (as shown in FIG. 2). This presents a scaling problem, especially when different vendors have a large number of different versions of an operating system of a device, where each version has different syntax and/or semantics. To mitigate this, the function of obtaining data (as exemplified in the set of vendor-specific converters) is separated from the function of processing that data (as exemplified by the semantic model-based processing logic).

FIG. 2 illustrates a block diagram of harmonization logic 200 according to at least one illustrative embodiment. The managed resources 165 are in communication with a first vendor-specific converter 210, a second vendor-specific converter 215, a third vendor-specific converter 220, and a fourth vendor-specific converter 225. The managed resources 165 may be comprised of a first managed resource 226, a second managed resource 227, and so forth, up to an Nth managed resource 228, where there are a total of N managed resources. A separate managed resource may exist, e.g. for each of the set of vendor-specific converters. Although only four vendor-specific converters are shown, it should be appreciated that more or fewer than four vendor-specific converters may be utilized, based on system requirements. Each of the vendor-specific converters is in communication with both the managed resources 165 and an XML converter 230. As shown, the first vendor-specific converter 210 is in direct communication with a first sensor 235. The first sensor 235 gathers vendor-specific data from the managed resources 165 and provides this data to the first vendor-specific converter 210. In a similar arrangement, a second sensor 240 gathers vendor-specific data from the managed resources 165 and provides this data to the second vendor-specific converter 215.

The first vendor-specific converter 210 has a function of normalizing the vendor-specific data into a format useable by the XML converter 230. Because there are potentially many different languages and devices contained within the managed resources 165, the harmonization logic 200 may include at least one vendor-specific converter, such as the first vendor-specific converter 210, for each different known language and device of the managed resources 165. Alternatively, at least some of the vendor-specific converters, such as the first vendor-specific converter 210 and the second vendor-specific converter 215 may have a capability of converting between more than one different language and device into the normalized data format. In other alternative embodiments, there may be more than one vendor-specific converter to convert from one particular language into the normalized data format. This arrangement would be useful, e.g. when the one specific language is very common and it is known that a large percentage of the received vendor-specific data are likely to be in that specific language.

An additional involves CLI and SNMP. In CLIs, a large percentage of the commands—their syntax and semantics—stay the same over each release. Hence, one can build a framework that parses these data and commands from each release and then add “blades” to handle incremental additions. SNMP is slightly different—one has a set of commands that are standard, and then a set of auxiliary commands that are vendor-specific. Hence, one builds a framework to handle the common data, and then blades to handle vendor-specific info.

The first vendor-specific converter 210 and the second vendor-specific converter 215 each provide the normalized data to the XML converter 230. The XML converter 230 has a function of converting the normalized data into a common format, such as normalized XML data. In other embodiments, the normalized data may be converted into another common format other than XML, depending on system requirements.

The XML converter 230 is in communication with each of the third vendor specific converter 220 and the fourth vendor-specific converter 225 to provide normalized commands. For example, whereas the first sensor 235 and the second sensor 240 are utilized to gather data from the managed resources 165 when a problem arises, the first effector 245 and the second effector 250 are, on the other hand, utilized to send commands to the managed resources 165 to correct the problem.

The vendor-specific converters all perform the same conceptually simple function. They compare inputs (sensor data or normalized commands) to the appropriate pattern(s) corresponding to a particular vendor, and then translate the raw input to a normalized form and vice-versa. Looking at the input path, the raw data and events gathered from the managed resources 165 are presented to the appropriate vendor-specific converters (in this example, the vendor-specific converter 210 and the second vendor-specific converter 215). This is the first step in translating vendor-specific information to an object-oriented common form that other components in the autonomic manager can work with. The output path consists of the translation of commands defined in the object-oriented common form used by the autonomic processing engine 160 to an appropriate set of vendor-specific converters (in this example, the third vendor-specific converter 220 and the fourth vendor-specific converter 225).

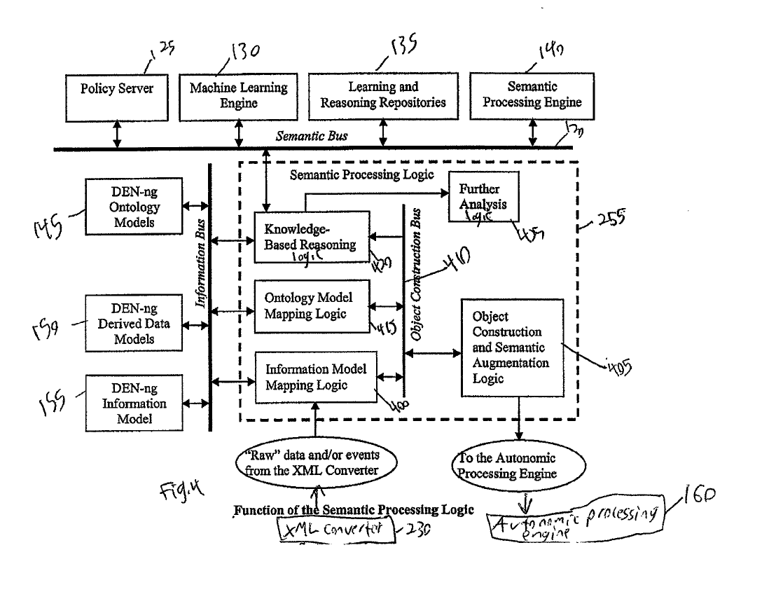

A plurality of vendor-specific converters can be used, even for the same device, since it may provide data and accept commands using multiple languages and/or protocols. Each converter may be built using, for example, extensions to the DEN-ng object-oriented model. This allows the model author to describe the event and/or data, protocol, and language that are being mapped. (The model mapping is described as part of the object construction and semantic augmentation process below with respect to FIG. 4.) It also enables reuse of similar concepts among different vendor-specific converters. Hence, this architecture scales by simply adding in desired input and/or output vendor-specific converters as required by the functionality of a given computing system.

There are two possible outputs from the vendor-specific converters: raw data and/or events are either converted into a normalized form, or they are simply passed through the appropriate vendor-specific converter unaltered (this connection is not shown in FIG. 2 for the sake of simplicity). This latter can happen for three reasons: (a) the appropriate vendor-specific converter failed to successfully process the data and/or event for some reason, (b) the data and/or event did not match data or commands from any known vendor, so no conversion could be done, or (c) unaltered/native data was solicited by a higher layer process, an example of which would be the control loop in the autonomic manager. If the conversion was successful, the normalized data is then passed to the XML converter 230 to be translated into XML. Otherwise, the non-normalized data is processed further.

The XML converter 230 is in communication with semantic processing logic 255. The semantic processing logic 255 receives normalized XML data from the XML converter 230 and provides normalized XML commands and/or objects to the XML converter 230.

The architectural construct referred to as further processing modules 260 in FIG. 2 is used to save a normalized form of the original data and/or events for machine learning of behavior for an element or aggregates of elements. This is because semantic information alone will not allow the use of statistical processes in the learning operation. The semantic processing logic 255 is in communication with the semantic bus 120, the information bus 115, and an autonomic processing engine 160.

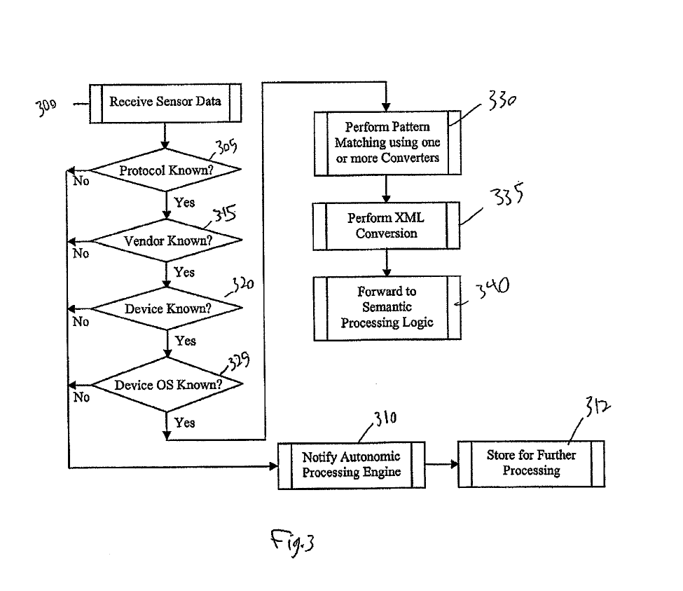

FIG. 3 illustrates a simplified flowchart for the model-based processing logic according to at least one illustrative embodiment. When the managed resources 165 have multiple ways to send data and accept commands, those ways are usually protocol-specific (e.g., managed objects in SNMP vs. an equivalent CLI representation in a Telnet session). Hence, the translation problem is segmented into a number of sequential steps. FIG. 3 shows the sequence of processing steps for each input vendor-specific converter (e.g. the first vendor-specific convert 210 and the second vendor-specific converter 215) shown in FIG. 2. Similar steps (but in reverse) apply for the output vendor specific converters (e.g. the third vendor-specific converter 220 and the fourth vendor-specific converter 225) shown in FIG. 2.

First, at operation 300, the vendor-specific data is received by at least one of the first vendor-specific converter 210 and the second vendor-specific converter 215. Next, a determination is made as to whether the protocol of the device is known at operation 305. The protocol may be determined by examining the protocol header format to determine the type of protocol being used. If the protocol is not known, processing proceeds to operation 310 where the autonomic processing engine 160 is notified and the sensor data is stored for further processing at operation 312. If the protocol is known, however, processing proceeds to operation 315 where a determination is made as to whether the identity of the vendor of the device is known. The determination of the vendor is made so that efficient communication with the managed resources 165 can be performed.

If the vendor is not known, processing proceeds to operation 310. If the vendor is known, however, processing proceeds to operation 320 where a determination is made as to whether the identity of the device itself is known. If the identity of the device is not known, processing proceeds to operation 310. If the identity of the device vendor is known, however, processing proceeds to operation 325 where a determination is made as to whether the identity of the device's operating system (“OS”) is known. If the identity of the device's OS is not known, processing proceeds to operation 310. If the identity of the device's OS vendor is known, however, processing proceeds to operation 330 where pattern matching is performed using one or more of the vendor-specific converters, such as the first vendor-specific convert 210 and the second vendor-specific converter 215.

Since the managed resources 165 may be able to communicate in multiple languages, operations 320 and 325 involve discovering the particular device (because often, different devices have limitations on the software that they can use) and the specific version of the device operating system (i.e., the language, since each version of a device operating system tends to have different syntax and semantics) that it is using. This enables the system to determine if the received data was an expected input in response to a command, or new data that may require further analysis. Without performing the method described above, this would not be possible. Vendor, device, and device operating system information can be obtained in a variety of ways, depending on the nature of the received data and/or events. For example, if the received data was an SNMP object, then vendor information will appear as part of the SNMP object. In contrast, if the received data was the output of a vendor-specific CLI command, then the vendor information will be embedded in the results of the CLI command.

If the protocol, vendor, device, and device operating system are all known, then the input conversion process can begin. This scheme employs pattern recognition techniques at operation 330 to match data and/or events from the sensors to pre-defined templates representing one or more functions of a vendor-specific device operating system. Given this information, the input vendor-specific converters (i.e., the first vendor-specific converter 210 and the second vendor-specific converter 215) can either directly match (with 100% probability) that given data corresponds to a particular command or set of commands, or hypothesize (with less than 100% probability) that given data most likely corresponds to a particular command or set of commands. This latter case enables these teachings to identify partial data received by the system. There may be many reasons for partial reception of data, including an error (such as truncation of transmission) or the loss of communication with the device. At this point, the sensor data is ready to be converted into a common format—XML.

Referring back to FIG. 3, at operation 335 an XML conversion is performed to convert the normalized data into normalized XML data. Finally, at operation 340, the normalized XML data is forwarded to the semantic processing logic 255 for further processing.

An important use case is when the received data may represent new information that the autonomic processing engine 160 needs to examine further. In this case, the autonomic processing engine 160 may need to gather related data to better understand the nature (e.g., the root cause) of the received data.

The outputs of the input vendor-specific converters are sent to the XML converter 230 at operation 335, which transforms the result of the input converters into the XML format. This enables other components of the system to operate on data in a common, platform-neutral format.

The output of the XML converter 230 is fed into the semantic processing logic 255. The semantic processing logic 255 accepts the input data in XML form and seeks to match it against three knowledge bases: first against the information model, next against the set of ontologies that are being used, and finally against the semantic model. These three knowledge bases represent facts, meaning and relationships of facts (as well as a generalization of facts into concepts), and the ability to reason with facts, respectively. This corresponds to a tradeoff between degrees of certainty and uncertainty concerning the received information, as well as the uncertainty that we have in making conclusions about the facts. In addition, it is related to the particular task being currently performed. That is, the task itself may require repeated retrieval of information based on the meaning of prior received data. This is discussed below with respect to FIG. 4.

FIG. 4 illustrates a functional block diagram of the semantic processing logic 255 according to at least one illustrative embodiment. Data and/or events from the XML converter 230 are first matched against the information model by information model mapping logic 400. This process uses pattern-matching techniques to see if the data and/or events are defined in the information model. If they are, then they are immediately passed to the object construction and semantic augmentation logic 405 via an object construction bus 410.

The object construction and semantic augmentation logic 405 constructs objects (DEN-ng objects in an embodiment) according to the match found in the information model mapping logic 400. This process uses the received data and/or events as an index into the information model, and then identifies the related set of objects that are found. For example, a received SNMP alarm will be matched in the information model mapping logic, since DEN-ng models SNMP alarms. However, in this particular example, the (single) SNMP alarm will be mapped into a set of DEN-ng objects, since the DEN-ng model associates other information with SNMP objects, and also splits apart data represented as tables in the SNMP object into their own separate objects for easier manipulation.

At this point, the object construction and semantic augmentation logic 405 determines whether the newly constructed objects need semantic augmentation. If they do not, then the newly constructed objects are matched against the current task being performed. If that task doesn't need any more data, then the newly constructed objects are sent to the autonomic processing engine 160. If the current task does need more data, however, then the object construction and semantic augmentation logic 405 will define queries to retrieve the additional data that it needs, and then issue the appropriate commands to get the required data, which will then be processed by the appropriate input vendor-specific converter(s).

On the other hand, if the newly constructed objects do need semantic augmentation, then semantic concept similarity matching is performed. This may be done by a variety of algorithms. This is almost identical to the next case, which routes the output of the XML converter 230 to the ontology model mapping logic 415 if the received data and/or events does not match the information model. The difference is the type of similarity matching that is performed. Ontology model mapping logic 415 and knowledge-based reasoning logic 420 may be utilized performing the similarity matching.

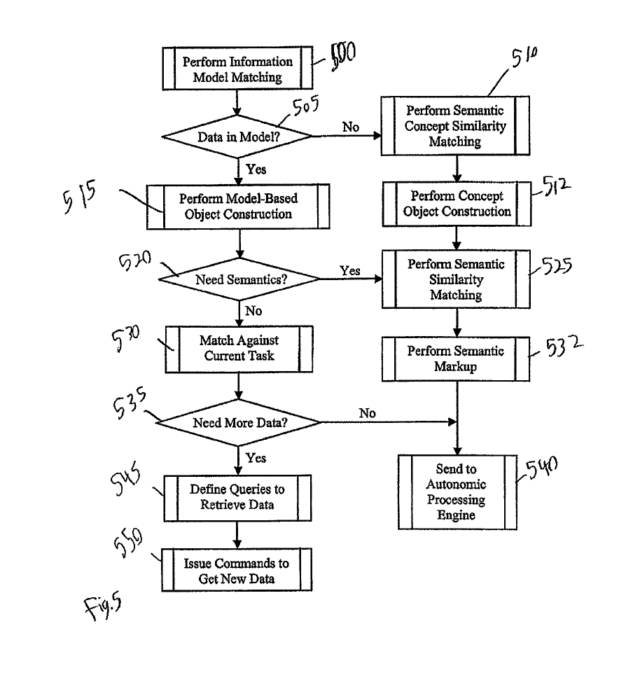

FIG. 5 illustrates the object construction and semantic augmentation processing according to at least one illustrative embodiment. If the received data and/or events from the sensors do not match the information model, then they are matched against the active set of ontologies that are currently being used. These teachings allow for a different set of ontologies to be loaded into the object construction and semantic augmentation processing logic 405 for two main reasons. First, it enables optimization of computations to be performed (e.g. constraining the search space based on context). The second reason is as directed by the autonomic processing engine via policy. The second reason is very powerful, as it enables the set of ontologies being used at any particular time to be matched to (for example) the current context that the system is operating in. This is called concept similarity matching.

Concept similarity matching analyzes the received data and/or events and then searches for corresponding concepts in the set of ontologies being used. If the received data and/or events do not match the ontology model mapping logic 415, then they are passed to the knowledge-based reasoning logic 420 for further analysis. The knowledge-based reasoning logic 420 will attempt to define the nature of the received data and/or events using learning and reasoning techniques. For example, it could analyze the received data and/or events, form a hypothesis as to the cause and effect of the received data and/or events, and then produce a set of queries to test the hypothesis.

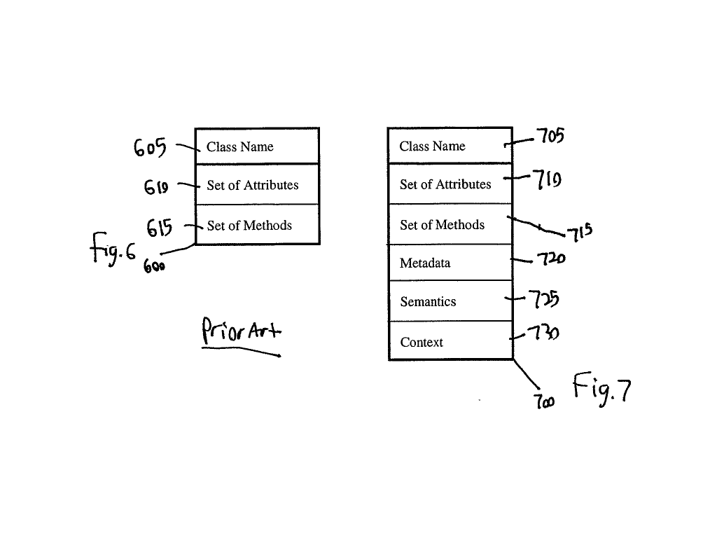

On the other hand, if a concept match is found, then objects representing each concept are constructed. This process relies on a set of pre-defined ontology-to-model mapping to construct (DEN-ng, in the preferred embodiment) objects that represent those concepts. This then enters the semantic similarity matching process. Conceptually the standard objects as represented in Unified Modeling Language (“UML”) (the information model) are transformed into semantically augmented objects (adding in ontological information), as discussed below with respect to FIGS. 6 and 7.

Referring to FIG. 5, at operation 500 an information model matching function is performed. Operation 500 corresponds to the information matching model logic 400, discussed above with respect to FIG. 4. Next, at operation 505, a determination is made as to whether the data is in the model. If “no,” processing proceeds to operation 510. If yes, however, processing proceeds to operation 515, where model-based object construction is performed. Next, at operation 520, a determination is made as to whether the object needs semantics. If “yes,” processing proceeds to operation 525. If “no,” however, processing proceeds to operation 530 where the object is matched against the current task. Next, at operation 535, a determination is made as to whether the object needs more data. If “no,” processing proceeds to operation 540. If “yes,” on the other hand, processing proceeds to operation 545 where queries are defined to retrieve the additional data. Finally, at operation 550, commands are issued to get new data.

Referring back to operation 510, a semantic concept similarity matching is performed on the received data and/or events. Next, at operation 512, concept object construction is performed. Concept object construction creates one or more constructs from input data (which may be information model data, another concept, and other inputs). Conceptually, it broadens the meanings associated with a particular input. In a preferred implementation, it weights each meaning (as in a dictionary definition) to aid the semantic processing of said information. Concept object construction is further described in U.S. patent application Ser. No. ______, entitled “METHOD AND APPARATUS FOR AUGMENTING DATA AND ACTIONS WITH SEMANTIC INFORMATION TO FACILITATE THE AUTONOMIC OPERATIONS OF COMPONENTS AND SYSTEMS,” as was filed on ______ using attorney's docket number CML03000N, the disclosure of which is incorporated by reference herein. Subsequently, at operation 525, a semantic similarity matching operation is performed. A semantic markup is then performed at operation 532. Finally, at operation 540, the concept object is sent to the autonomic processing engine 160.

FIG. 6 illustrates an object 600 represented in UML according to the prior art, and FIG. 7 illustrates a semantically augmented object 625 that accords with these teachings. As shown, the object 600 of FIG. 6 includes a class name 605, attributes 610, and methods 615. The semantically augmented object 700 of FIG. 7, on the other hand, includes a class name 705, attributes 710, methods 715, metadata 720, semantics 725, and context 730.

In general, there is a one-to-many mapping that is enabled by the contextual, situational, and/or conditional adjunct information that already resides in the autonomic processing engine 160. The semantic markup maps a combination of state, event, and condition data into an object-oriented form that can be efficiently processed in an autonomic control loop.

An important benefit of this process is that this allows for simultaneous evolution of managed element, converter, and autonomic control loop functionality. Metadata 645 and context 655 are, for these purposes, specialized types of semantics 650. Metadata 645 is generated to enable easier semantic processing for future computation. It contains a list of keywords to reference both global concepts as well as other objects that a given object relates to. Context 655 is derived through the semantic similarity matching process. In essence, the similarity matching process identifies objects that relate to each other. Logic then analyzes the resultant set of objects to determine the set of those objects that form the context of the event (e.g., where did the event originate from, why was it sent, and so forth).

The output of the semantic similarity function provides a set of matches (not just the “best” match), each element of which is assigned a weighting value. The weighting value can be used by various optimization algorithms to determine which sets of data are similar according to a set of programmable parameters.

Semantic similarity enables the high-level modeling abstraction of capabilities and constraints to be introduced. The capabilities abstraction transforms different commands and functions of the managed resources 165 into a common, normalized superset. The constraints abstraction represents the set of restrictions on using a given set of capabilities. For example, different vendors support the concept of BGP, but implement different options defined for the protocol. Hence, these teachings define a set of hierarchical capabilities representing the concept of BGP (at the top level) and specific options for controlling BGP functionality (organized as a hierarchy). Similarly, a set of hierarchical constraints is defined that represent restrictions on using these capabilities (for example, based on maintaining interoperability, or for regulatory conditions). These two abstractions are requirements in order to autonomically control network functions, due to the variety of vendors used in a typical network, with each vendor device supporting different data, languages, and programming models. Semantic similarity enables matching of functions that are not exactly equivalent to be done, enabling a management function to issue a single normalized command to the framework, and the framework translate that to the closest function that matches the normalized function for each of the heterogeneous elements comprising the solution.

The final process is to markup the XML objects with semantic information. At this point, the semantic processing logic 255 has transformed normalized XML into semantically-augmented XML Objects. This enables received as well as to-be-issued data and commands to fill in various grammatical roles in a language that is used to represent policy-based management.

The set of active policies determine if the set of semantically-augmented XML objects should be passed directly to the autonomic processing engine 160, or if they should be further augmented with additional semantics. The former is useful when the autonomic processing engine 160 is (for example) looking for specific data. The latter, on the other hand, is useful for many reasons (e.g. root cause analysis) and is the most general case.

There are two final cases to be considered: (1) failure of an input converter to translate received events and/or data, resulting in non-normalized data, and (2) reception of new data and/or events that have not yet been modeled in the system. The teachings discussed herein handle both of these cases the exact same way, as described below.

As discussed above, FIG. 4 shows the processing needed to convert non-normalized data into a form that can be sent to the XML converter 230. The non-normalized data is first compared to other data in the DEN-ng data models using one or more pattern-matching mechanisms. If that fails, then it is examined for ontological similarity to existing knowledge contained in the set of DEN-ng ontologies. If that fails, then additional knowledge-based reasoning techniques are used. An objective of these three types of mappings is to identify the data or, when reasoning is used, to hypothesize about the data. If at any time the data is matched, it is sent to either the object construction or the concept object construction processes as shown in FIG. 5. If the data cannot be matched, then it is archived for further offline processing.

There are a number of advantages of the teachings discussed herein. These teachings provide a common machine-readable form of different types of data from different languages having different formats, datatypes, syntax, and semantics. It also separates the process of understanding received data from operating on that understanding. It separates the process of deciding on an action from constructing the commands to implement that action. It scales through modularity, i.e., new devices can be controlled by adding a new module built to do device-specific translation. This is superior to placing this functionality directly in the autonomic management portion of the system, since then the autonomic manager must have device-specific knowledge about each and every device that it needs to manage. In contrast, the present architecture places this translation function into a pre-processor that then provides information to the autonomic manager.

It scales through software reuse, i.e., the building of a new device translator can reuse software from existing device translators. More importantly, it does not adversely affect other parts of the autonomic system.

It pre-processes information for the autonomic system, off-loading common functions from it and thereby decreasing the complexity of the autonomic manager (note that this adheres to the basic principle of autonomics, which is to define many simple functions to do a complex task instead of a single complex function to do a complex task). It abstracts the specification of this function from any specific implementation; hence, it can be used with new and/or legacy devices.

It uses a plurality of approaches to translate and, more importantly, attach semantic meaning, to the received events and/or data. It also uses case-based reasoning using facts defined in an information model to achieve an inherently modular and efficient structure to the translation process, which is lacking in previous implementations.

It enables new data to be dynamically recognized and categorized by using information modeling and ontology engineering. It differentiates between a direct match (with 100% probability) that given data corresponds to a particular command or set of commands, and situations with less than 100% probability of a match. This enables a rank-ordered set of probabilities that given data most likely corresponds to a particular command or set of commands.

The ability to provide probability-based matching enables these teachings to identify partial data received by the system. It also enables the separation of the collection of data, its interpretation into situation and event data, and actions resulting from that interpretation into separate processes. It further enables hypotheses formulation as to why partial data was received (e.g., determination of whether an error did occur (such as truncation of transmission) or whether there was a loss of communication with the managed resources 165).

It defines a software architecture that enables a modular, extensible information representation and application to be realized. It is modular because it defines a set of software objects that can be made up of higher-level modules that can be added or taken away to extend or restrict the overall functionality of the system without impairing its core functionality. Moreover, it is extensible in that it can be dynamically added to without impairing the functionality of the system.

The above-mentioned flexibility and functionality of the system can be used to implement a variety of different paradigms. These paradigms are rooted in the use of one or more of the four functional areas of these teachings: information and data modeling, ontological engineering, machine learning, and knowledge-based reasoning.

It enables new data to be dynamically recognized and categorized by using a plurality of information modeling, ontology engineering, machine learning, and knowledge-based reasoning processes. It also uses knowledge-based reasoning and state awareness to attach semantics to received data and events, thereby reducing the processing processes required in the autonomic computing management system.

It uses policy-based management techniques to govern which types of data it is looking for, and which set of commands it will issue. It uses machine learning techniques to learn behavior for elements and aggregates of elements to adjust internal representations to state and events allowable under various states. It uses machine learning techniques to learn behavior sufficient to assist in predictive or inductive inferencing operations (i.e., inductive hypothesis generation). It further uses knowledge-based reasoning techniques to alter the gathering of data according to previous data and current hypotheses that are generated (e.g., abductive hypothesis generation).

These teachings translate data and commands in multiple distinct formats from multiple different vendors into a single harmonized form using a combination of object-oriented information modeling and semantic knowledge. These teachings also include facilities to dynamically adapt to new data and information formats. Thus, a single computing system can get data from and issue commands to different devices, even if those devices cannot communicate directly with each other, by using these teachings.

In the context of these teachings, “a single harmonized form” means that data and commands are automatically translated to a common format, and vice-versa. This provides at least three important capabilities in computing systems. First, it allows different devices and computing systems using different languages to communicate with each other by defining a common communication and control mechanism. Second, it facilitates the use of policy governing processing logic that is independent of an underlying implementation. Third, it facilitates the use of machine learning and reasoning techniques to actively observe the processes of these teachings and, based on those observations, adjust other control and management processes of the autonomic system. For example, a policy written to govern a network comprising Cisco routing equipment would immediately apply to equivalent networks implemented using routing equipment of other vendors, even though their configuration systems differ markedly. As another example, knowledge-based reasoning can observe the harmonization process and recommend the collection of different data (as well as changing which aspects of which managed resources are being observed) based on the type and frequency of received data and events from the original managed resources.

Generally speaking, pursuant to these various embodiments, a method, apparatus, and system are provided that describe a set of mechanisms that translate data and commands in multiple distinct formats from multiple different vendors into a single harmonized form using a combination of object-oriented information modeling and semantic knowledge. It also includes facilities to dynamically adapt to new data and information formats. A method, apparatus, and system are also provided that describe a set of mechanisms that translate data in the single harmonized form back into multiple distinct formats from multiple different vendors using a combination of object-oriented information modeling and semantic knowledge. Thus, according to these teachings, a single computing system can acquire data from and issue commands to different devices, even if those devices cannot communicate directly with each other.

These teachings are directed to a method involving accepting at least a first input and a second input from a plurality of sensors. The first input corresponds to a first language, and the second input corresponds to a second language. The first language is different from the second language. At least one computational function is performed on the at least the first input and the second input according to at least one of installed policies and an input from an autonomic manager. The at least the first input and the second input is harmonized into an output corresponding to a common language for use by the autonomic manager.

The common language may be XML. The at least one computational function comprises determining, for the at least the first input and the second input, at least one of: a protocol delivering data, a vendor, an identity of an entity, and a version of a device operating system that is used to perform at least one of programming and controlling the entity. The at least one computational function may comprise comparing the first input and the second input to predetermined patterns corresponding to a particular vendor.

The accepting may comprise receiving the at least a first input and a second input from a managed resource. The output may be matched against an information model and at least one new object may be constructed based on a successful match. In response to determining that the at least one new object does not need semantic augmentation, the at least one new object may be matched against a current task being performed. In response to determining that the current task needs more data, queries may be defined to retrieve additional data for the at least one new object based on the content of the at least one new object.

At least one semantic concept similarity matching function and a semantic markup on the at least one new object may be performed in response to determining that the at least one new object needs semantic augmentation. The set of object construction and semantic concept similarity matching differentiates between an absolute match corresponding to at least one particular command, and a non-absolute match. An absolute match is a match made with 100% certainty. A non-absolute match is a match made with less than 100% certainty. This enables a rank-ordered set of probabilities that given data most likely corresponds to a particular command or set of commands.

The teachings discussed herein are also directed to a system comprising vendor specific converters. The vendor-specific converters gather vendor-specific data from a plurality of sensors and convert the vendor-specific data to normalized data. The vendor-specific data comprises at least a first input and a second input. The first input corresponds to a first language and the second input corresponds to a second language. The first language is different from the second language. The vendor-specific converters also receive normalized commands and issue vendor-specific commands to a managed resource.

A converter module receives the normalized data and converts the normalized data to an output corresponding to a common language, and receives normalized commands corresponding to the common language and outputs the normalized commands. Semantic processing logic receives the output and matches the output against a predetermined set of knowledge bases and generates at least one new object to send to an autonomic manager.

The set of knowledge bases comprises an information model, a least one ontology, and a semantic model. The common language is XML. A managed resource provides the first input and the second input. The system may also have object construction logic to match the output against an information model and construct the at least one new object based on a successful match.

The object construction logic may have a processing element. In response to determining that the at least one new object does not need semantic augmentation, the processing element matches the at least one new object against a current task being performed. In response to determining that the task needs more data, queries are defined to retrieve additional data for the at least one new object.

The processing element may also, in response to determining that the at least one new object needs semantic augmentation, perform at least one semantic concept similarity matching function and a semantic markup on the new object. The processing element may further determine at least one concept that is similar to at least one of the first input and the second input, to determine additional meaning and context of the at least one of the first input and the second input. The concept similarity matching function will then be used to generate new semantics, which may in turn generate new objects.

The set of object construction and semantic concept similarity matching can differentiate between a directly match (with 100% probability) that given data corresponds to a particular command or set of commands, and situations with less than 100% probability of a match. This enables a rank-ordered set of probabilities that given data most likely corresponds to a particular command or set of commands

The teachings above are also directed to an apparatus having vendor specific converters. The vendor-specific converters gather vendor-specific data from a plurality of sensors and convert the vendor-specific data to normalized data. The vendor-specific data comprises at least a first input and a second input. The first input corresponds to a first language and the second input corresponds to a second language. The first language is different from the second language. The vendor-specific converters also receive normalized commands and issue vendor-specific commands to a managed resource. A semantic model converter (a) receives the normalized data, (b) outputs the normalized commands, and (c) matches the normalized data against a predetermined set of knowledge bases and generates a new object to send to an autonomic manager.

The set of knowledge bases comprises an information model, a least one ontology, and a semantic model. The apparatus further comprises object construction logic to match the normalized data against an information model and construct the new object based on a successful match. Policy-based management techniques may be used to govern which types of data the autonomic manager is looking for, and which set of commands it will issue. Policy-based management techniques can also be used for governing how to represent data—this is an important and often overlooked point, as it enables the translation and harmonization of the data to match the needs of the program and/or application that is requesting it.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the current inventive concept. For example, although some embodiments described above utilize DEN-ng models, it should be appreciated that models other than DEN-ng may also be utilized.

We claim:

1. A method, comprising:
accepting at least a first input and a second input from a plurality of sensors, the first input corresponding to a first language, and the second input corresponding to a second language, wherein the first language is different from the second language;
performing at least one computational function on the at least the first input and the second input according to at least one of installed policies and an input from an autonomic manager; and
harmonizing the at least the first input and the second input into an output corresponding to a common language for use by the autonomic manager.

2. The method of claim 1, wherein the common language comprises Extensible Markup Language (“XML”).

3. The method of claim 1, the at least one computational function comprising determining, for the at least the first input and the second input, at least one of: a protocol delivering data, a vendor, an identity of an entity, and a version of a device operating system that is used to perform at least one of programming and controlling the entity.

4. The method of claim 1, the at least one computational function comprising comparing the first input and the second input to predetermined patterns corresponding to a particular vendor.

5. The method of claim 1, the accepting comprising receiving the at least a first input and a second input from a managed resource.

6. The method of claim 1, further comprising matching the output against an information model and constructing at least one new object based on a successful match.

7. The method of claim 6, wherein in response to determining that the at least one new object does not need semantic augmentation, matching the at least one new object against a current task being performed and in response to determining that the current task needs more data, defining queries to retrieve additional data for the at least one new object based on the content of the at least one new object.

8. The method of claim 6, wherein in response to determining that the at least one new object needs semantic augmentation, performing at least one semantic concept similarity matching function and a semantic markup on the at least one new object.

9. The method of claim 6, wherein the set of object construction and semantic concept similarity matching differentiates between an absolute match corresponding to at least one particular command, and a non-absolute match.

10. A system, comprising:
vendor specific converters to:
gather vendor-specific data from a plurality of sensors and convert the vendor-specific data to normalized data, the vendor-specific data comprising at least a first input and a second input, the first input corresponding to a first language and the second input corresponding to a second language, wherein the first language is different from the second language, and
receive normalized commands and issue vendor-specific commands to a managed resource;
a converter module to:
receive the normalized data and convert the normalized data to an output corresponding to a common language, and
receive normalized commands corresponding to the common language and output the normalized commands; and
semantic processing logic to receive the output and match the output against a predetermined set of knowledge bases and generate at least one new object to send to an autonomic manager.

11. The system of claim 10, wherein the set of knowledge bases comprises an information model, a least one ontology, and a semantic model.

12. The system of claim 10, wherein the common language is Extensible Markup Language (“XML”).

13. The system of claim 10, further comprising a managed resource to provide the first input and the second input.

14. The system of claim 10, further comprising object construction logic to match the output against an information model and construct the at least one new object based on a successful match.

15. The system of claim 14, the object construction logic comprising a processing element, wherein in response to determining that the at least one new object does not need semantic augmentation, the processing element matches the at least one new object against a current task being performed and in response to determining that the task needs more data, defines queries to retrieve additional data for the at least one new object.

16. The system of claim 14, the object construction logic comprising a processing element, wherein in response to determining that the at least one new object needs semantic augmentation, the processing element performs at least one semantic concept similarity matching function and a semantic markup on the new object.

17. The system of claim 16, wherein the processing element determines at least one concept that is similar to at least one of the first input and the second input, to determine additional meaning and context of the at least one of the first input and the second input.

18. An apparatus, comprising:
vendor specific converters to:
gather vendor-specific data from a plurality of sensors and convert the vendor-specific data to normalized data, the vendor-specific data comprising at least a first input and a second input, the first input corresponding to a first language and the second input corresponding to a second language, wherein the first language is different from the second language, and
receive normalized commands and issue vendor-specific commands to a managed resource; and
a semantic model converter to:
receive the normalized data,
output the normalized commands, and
match the normalized data against a predetermined set of knowledge bases and generate a new object to send to an autonomic manager.

19. The apparatus of claim 18, wherein the set of knowledge bases comprises an information model, a least one ontology, and a semantic model.

20. The apparatus of claim 18, further comprising object construction logic to match the normalized data against an information model and construct the new object based on a successful match.
